(19) United States
(12) Patent Application Publication
(10) Pub. No.: US 2022/0072738 A1
(43) Pub. Date: Mar. 10, 2022

(54) AUTOMATED PLACEMENT OF PREPREG TAPES TO FORM COMPOSITE PARTS

(71) Applicant: CYTEC INDUSTRIES INC., Princeton, NJ (US)

(72) Inventors: Scott ROGERS, Placentia, CA (US); Stephen J. HOWARD, Chino, CA (US); Scott LUCAS, Anaheim, CA (US); Dominique PONSOLLE, Winona, MN (US)

(21) Appl. No.: 17/416,363

(22) PCT Filed: Dec. 21, 2019
(86) PCT No.: PCT/US2019/068197

§ 371 Date: Jun. 18, 2021

Related U.S. Application Data
(60) Provisional application No. 62/783,972, filed on Dec. 21, 2018.

(51) Int. Cl. B29B 15/10; B29C 70/08; B29C 70/38; B29C 70/50; B29C 70/54; B29C 65/02

(52) U.S. Cl. CPC B29B 15/105; B29C 70/081; B29C 70/086; B29C 65/02; B29C 70/506; B29C 70/545; B29C 70/386

(57) ABSTRACT

Prepreg tapes suitable for automated placement process are formed by slitting a sheet of partially impregnated prepreg. The partially impregnated prepreg is composed of unidirectional fiber tows partially embedded in a resin layer and has a continuous resin surface only on one side. In some embodiments, one or two nonwoven veil(s) is/are incorporated into the partially impregnated prepreg.

The instant application claims the benefit of prior U.S. Provisional Application No. 62/783,972 filed on Dec. 21, 2018, the content of which is incorporated herein by reference in its entirety.

The present disclosure generally relate to the fabrication of composite parts.

### BRIEF DESCRIPTION OF THE DRAWINGS

FIGS. 1A-1B illustrates a method for forming a partially impregnated prepreg according to one embodiment.

FIGS. 2A-2B illustrates a method for forming a partially impregnated prepreg according to another embodiment.

FIG. 3 shows a partially impregnated prepreg containing toughening particles according to another embodiment.

FIG. 4 shows a partially impregnated prepreg without a nonwoven veil according to another embodiment.

FIG. 5 is an optical image showing a cross-sectional view of a cured composite laminate prepared by Automated Fiber Placement (AFP) using conventional tacky prepreg tapes.

FIG. 6 is the top view of a slit, partially-impregnated prepreg prepared according to one example.

FIG. 7 is an optical image showing a cross-sectional view of a cured composite laminate prepared by using one-side tacky prepreg tapes prepared according to one example.

### DETAILED DESCRIPTION

Composite materials consisting of a matrix resin and reinforcement fibers are typically used in areas where high strength and low weight are important, for example, aircraft parts. Most composites used for aerospace structural applications comprise thermosetting resins and high-strength fibers such as continuous carbon fibers. Typically, these thermosetting resins are cured at high temperature (e.g., 250-350° F. or 121-177° C.) and under high pressure (e.g., 85 psi or 586 kPa) using an autoclave.

A conventional manufacturing method for forming composite parts is a prepreg lay-up process, in which sheets of resin-impregnated composite material called “prepregs” are laid up, one on top of another, in a stacking arrangement on a tool surface that can reproduce the shape of the composite part. The layup of prepregs are then consolidated and cured to produce a hardened composite part.

A major problem encountered in the manufacture of thick composite parts is porosity (or voids) in the final composite part. Void formation and growth in composite laminates is primarily due to entrapped volatiles. Composite parts processed under similar conditions have been found to result in significantly different void levels resulting in production slowdowns. Void formation seriously compromises the mechanical properties of the composite material and in many cases requires large repair costs due to rejection of parts.

One way in which a void-free laminate can be manufactured is to utilize an autoclave. An autoclave is capable of subjecting the layup of prepregs to elevated temperatures and pressures so that they can readily coalesce to form a reinforced composite material. If the pressure is maintained during the gelation of the resin and its subsequent cure, a void-free matrix is achieved. However, while pressure application from an autoclave is attractive in view of its potential for providing a void-free reinforced composite part, it is nevertheless expensive in view of the high capital cost of the equipment involved. Furthermore, autoclaving is deemed undesirable when the size of the reinforced composite part is too large to be efficiently cured in such a manner. Additionally, when making reinforced composite parts at low production rates, low cost tools made of wood or low glass transition temperature polymer tools are commonly used. When these tools are used, however, composite parts can only be cured using relatively low temperatures and pressures. Thus, the use of an autoclave is not practical in these circumstances.

A cheaper alternative to using an autoclave is a vacuuming process called Vacuum Bag Only (VBO) in which the layup of prepregs is placed on a tool surface and then enclosed by an gas-impervious, flexible membrane (called “vacuum bag”). The volume enclosed by the membrane is evacuated and the assembly of prepreg layup and tool is heated up slowly. While pressure application using a vacuum bag is more cost effective than employing an autoclave, the resulting laminate is usually of inferior quality because of the occurrence of voids in the resin matrix. The voids are trapped in both the matrix resin and interlaminar regions between sheets or plies of prepregs.

A solution to the void problem is to use partially impregnated prepregs in the layup process. The partially impregnated prepreg consists of a fiber layer partially impregnated with a curable resin composition. When a layup of partially impregnated prepregs are heated in a VBO process, the resin fully infuses into the fiber layer, filling in the resin-free areas. Once cured, a void-free laminate is achieved.

The partially impregnated prepreg can be fabricated by pressing a resin film or two resin films onto one surface or side of a fiber layer (e.g. fabric) such that the resin penetrates partly through the thickness of the fiber layer. Preferably, both the top and bottom surfaces or sides of the fiber layer are partially impregnated when preparing the partially impregnated prepreg such that there is a resin-free region of dry fibers in the middle of the prepreg. The resin-free region in the prepreg provides escape path through which entrapped air and/or other volatiles in the prepreg may be removed when a vacuum is applied to the prepreg layup. Typically, such partially impregnated prepreg contains a resin content from about 25% to about 50% by weight based on the total weight of the resin and fiber layer.

Although such partially impregnated prepregs can be used to fabricate void-free composite laminate, they cannot be slit into narrow-width, continuous strips, also called “prepreg slit tapes”, that are suitable for automated placement processes such as Automated Reinforcement Laying (ATL) and Automated Fiber Placement (AFP) due the low resin content or lack of resin in the fiber bed which leads to fuzzy slit product with poor width control, thereby jamming the fiber placement machine.

ATL and AFP have been used to increase speed and efficiency of the lay-up process. ATL or AFP process involves automatically dispensing a plurality of narrow-width, flat strips of material such as prepreg tapes, side by side, onto a tool surface to create a layer of large dimensions, referred to as a “ply”. This automated placement method is done at high speed and is typically capable of laying down prepreg tapes in a variety of configurations corresponding to the surface of a selected tool surface that reproduces the shape of the final composite part. Control of the slit edge quality is required to maintain lay-down speeds and to avoid gaps and overlaps in the lay-up which lead to defects in the cured part structure.

An ATL or AFP machine commonly includes a placement head, a robotic system for moving the placement head in different directions across a tool surface, storage creels on which continuous strips of prepreg tapes, are wound, and mechanisms for guiding the tapes from the creels onto the placement head. The placement head includes a rotatable compaction roller and conveying means for conveying the tapes from the creels to the compaction roller. The compaction roller is configured to come into contact against the tool surface in order to apply the tapes against the tool surface or a prior disposed ply of tapes. The machine further includes cutting means, e.g. a blade, for cutting the length of the continuous reinforcement from the supply creel. The placement head may be configured to deposit multiple tapes simultaneously during a single passage.

It is desirable to be able to use AFP machines that automatically lay down slit thermoset prepreg tapes to produce composite structural parts, which can be subsequently cured in a vacuum bag system. The impregnation method common in the industry is a dual film approach that places the air removal mechanism at the centerline of the fiber tows. The need to slit the prepreg to narrow widths further defines the minimum level of impregnation which reduces the amount of dry fiber at the centerline, which in turn restricts air evacuation while trapping air between two tacky plies. Slitting of a resin-impregnated prepreg would require high impregnation level, typically, above 90%. Such impregnation level can measured by a water pickup test, whereby a sample of prepreg uptakes water, in the fiber direction, into the dry fiber spaces within it. Below this level of impregnation, the dry fibers within the prepreg become dislodged during slitting. Thus, the air removal mechanism is hindered by the higher level of impregnation required for slitting.

The present disclosure provides an automated placement process that is intended to solve the aforementioned issues relating to slitting performance, level of impregnation, and interlaminar porosity. This process includes forming a sheet of partially impregnated prepreg and slitting the same into continuous prepreg tapes. The length of the tape is continuous or is very long relative to its width, for example, 100-100,000 times its width. The partially impregnated prepreg tape may have a width of about 0.125 in to about 12 in (or about 0.3 cm to about 30.5 cm). In one embodiment, the prepreg tape has a width of about 0.125 in to about 2.0 in (or about 0.3 cm to about 5.0 cm), or about 0.25 in to about 0.50 in (or about 0.6 cm to about 1.28 cm). In another embodiment, the tape has a width of about 6 in to about 12 in (or about 15.2 cm to about 30.5 cm). In continuous form, the surfacing tape can be wound up into a roll for storage before its application in an automated process.

To form a composite laminate, the prepreg tapes are laid up via an automated placement process, e.g., ATL or AFP, on a tool or mold surface to form a composite laminate. In the ATL/AFP process, individual prepreg tapes are laid down directly onto a mandrel or mold surface at high speed, using one or more numerically controlled placement heads to dispense, clamp, cut and restart each tape during placement. The prepreg tapes are dispensed side by side to create a layer of a desired width and length, often including controlled gaps between tapes to aid evacuation, and then additional layers are built onto a prior layer to provide a prepreg layup with a desired thickness. The subsequent tapes may be oriented at different angles relative to prior tapes. The ATL/AFP system is equipped with means for dispensing and compacting the tapes directly onto the mandrel surface.

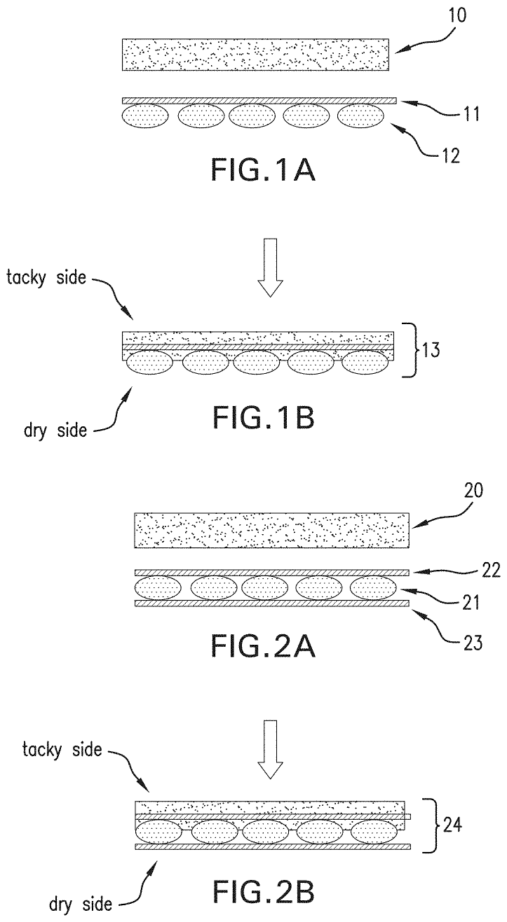

FIGS. 1A and 1B illustrate a method for forming a partially-impregnated prepreg according to one embodiment. In this embodiment, a layer of curable resin 10 is pressed onto a nonwoven veil 11 which is adjacent to a layer of unidirectional fibers in the form of tows 12 so as to form a partially-impregnated prepreg 13. Preferably, the nonwoven veil 11 the fiber tows 12 are bonded to each other as a fibrous laminate prior to being impregnated with the resin. The term “unidirectional” means aligning in parallel in the same direction. Each fiber tow 12 is a bundle of a plurality of continuous fiber filaments. The curable resin layer 10 is pressed onto the veil 10 and fiber tows 12 with the application of heat and/or pressure. The application of heat causes the resin 10 to soften. The soften resin 10 impregnates the nonwoven veil 11 completely but only partially impregnates the layer of unidirectional fiber tows 12, resulting in a partially-impregnated prepreg 13 with a continuous resin surface on one side, referred to as the “tacky side”, and an opposite dry, non-tacky side, which does not have such continuous resin surface. The tacky side is attributed to the presence of the uncured resin 10, which is tacky at room temperature (20° C. to 25° C.). The term “tacky” as used in reference to the resin surface means that it is sticky to the touch.

The mass of resin in the partially impregnated prepreg is referred to as the matrix resin. The nonwoven veil is embedded in the matrix resin, i.e., the nonwoven veil is inside the resin matrix, while the fiber tows are not completely surrounded by the matrix resin.

The term “impregnate” in this context refers to infusing or introducing a molten or liquid resin into interstices or openings of a fibrous material. In reference to the layer of unidirectional fiber tows 12, the phrase “partially impregnated” refers to the partial penetration of the resin 10 into the spaces between the unidirectional fiber tows such that the fiber tows are partly surrounded by the resin, i.e., are not completely surrounded by the resin.

Prior to resin impregnation, the nonwoven veil 11 and the layer of unidirectional fiber tows 12 may be bonded to each other using at least one binder to enhance the bonding. In a preferred embodiment, a combination of different binders is applied. Alternatively, the nonwoven veil 11 is formed of a thermoplastic material that can be thermally bonded to the layer of unidirectional fiber tows 12 by application of heat and pressure.

In the embodiment shown by FIG. 1B, the resin content of the partially impregnated prepreg 13 is from about 25% to about 50% by weight based on the total weight of the prepreg.

In another embodiment, illustrated by FIGS. 2A and 2B, a curable resin layer 20 is pressed onto an assembly of unidirectional fiber tows 21 sandwiched between two nonwoven veils 22 and 23 to form a partially impregnated prepreg 24. The fibers tows may be bonded to the two nonwoven veils prior to resin impregnation. Only one of the veil is embedded in the curable resin layer 20 in the final prepreg 24, and the fiber tows are not completely surrounded by the matrix resin. The partially impregnated prepreg 24 has a tacky side due the presence of the resin and an opposite dry, non-tacky side attributed to the outer nonwoven veil 23, which is free of such resin.

In the embodiment shown by FIG. 2B, the resin content of the partially impregnated prepreg 24 is from about 25% to about 50% by weight based on the total weight of the prepreg.

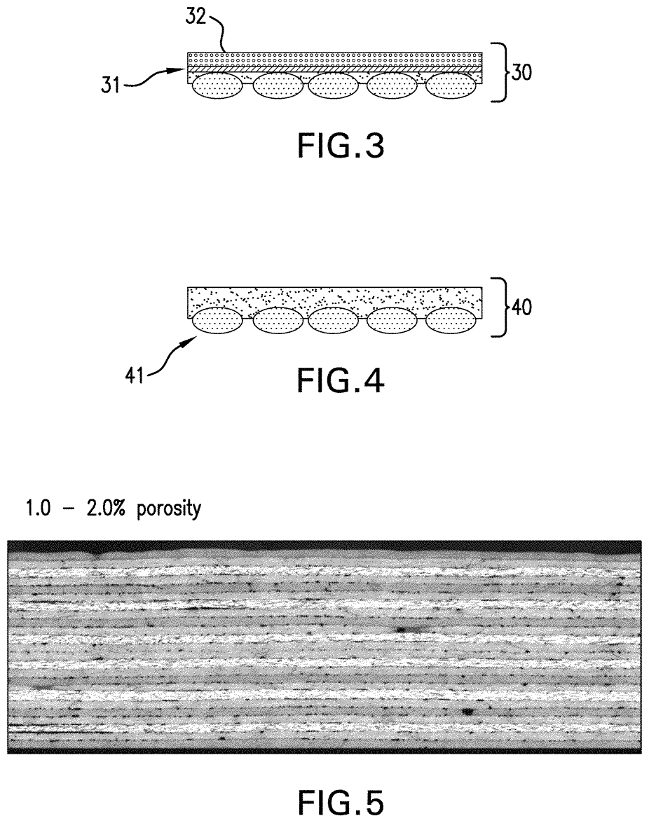

In one embodiment, the resin layer in FIG. 1A or FIG. 2A contains polymeric toughening particles such that, when the resin layer is pressed into the fibrous laminate, the particles are filtered out by the nonwoven veil and are located only on one side of the nonwoven veil. FIG. 3 illustrates a partially impregnated prepreg 30 with particles on one side of the embedded nonwoven veil 31.

The partially impregnated prepreg described above is slit using a conventional cutting machine to form a plurality of narrow-width, continuous strips of prepreg, i.e., prepreg tapes, having a length that is at least 10 times its width, for example, 100 to 1000 times its width. Slitting is preferably along the longitudinal length of the fiber tows. One advantage of the disclosed prepreg configuration is that slitting can be carried out without creating fuzz at the cut edges. Moreover, slitting can be carried out without any polymeric backing sheet or release paper attached to either side of the initial prepreg ply. Any backing sheet or release paper used during the formation of the partially impregnated prepreg is removed prior to slitting. For use in an automated placement machine such as ATL/AFP machines, the prepreg tapes may have a width of up to 5 cm (or 2 in in). According to one embodiment, each tape has a width within the range of 0.6 cm-5 cm or 0.32 cm-1.28 cm, and a length that is at least 100 times its width. Optionally, a release liner (which may be made of polyester) is applied to the tacky resin surface of the slit prepreg tape and the slit prepreg tape together with the release liner is wound onto a spool. The release liner is wider in dimensions than the prepreg tape and functions to prevent the tacky resin surface of the prepreg tape from adhering to the dry side while being wound on a spool. Such spools can be installed into an ATL/AFP machine.

FIG. 4 shows another embodiment in which the partially impregnated prepreg 40 does not include any nonwoven veil. In this embodiment, the fiber tows 41 are pre-treated with a binder composition prior to resin film impregnation. The fiber tows are arranged in parallel without any gap between the tows. It is not necessary to have gaps between the fiber tows for the purpose disclosed herein, however, small gaps are possible to allow further penetration of the resin film into the fiber layer. In one embodiment, a liquid binder composition (to be described in further details below) is applied to a layer of unidirectional fiber tows, then a resin layer is pressed into the unidirectional fiber tows to form the partially impregnated prepreg shown in FIG. 4. Alternatively, the liquid binder composition is applied to the carbon fibers at the end of the carbon fiber manufacturing process and prior to bundling the fibers into tows. The binder-treated fiber tows are then used in resin film impregnation to form the partially impregnated prepregs.

The partially impregnated prepreg of the present disclosure preferably has a low level of impregnation, up to 87%, in some embodiments, 75%-87%, as determined by water pick-up test.

Veil/Fibers Assembly

In embodiments in which the nonwoven veil is present, the nonwoven veil for use in the partially impregnated prepreg may comprise fibers that are randomly oriented or randomly arranged. The veil's fibers may include inorganic fibers or polymeric fibers. In some embodiments, the veil is composed of carbon fibers or thermoplastic fibers or a combination carbon and thermoplastic fibers. The fiber length may vary from ⅛ in (0.32 cm) to 2 in (5.08 cm) long. The areal weight of the nonwoven veil in this embodiment is preferably less than 10 grams per square meter (gsm).

Alternatively, the nonwoven veil is in the form of a thermoplastic grid or a porous, thermoplastic membrane with a controlled pattern of apertures. The thermoplastic grid or porous membrane may have an areal weight in the range of 2-50 gsm, preferably 2-20 gsm, more preferably 2-10 gsm.

Prior to resin impregnation, the unidirectional fibers (in the form of tows) and the nonwoven veil may be bonded to each other using one or more binders to enhance bonding. According to one embodiment, a method for applying binder includes: applying a binder, in particulate form or liquid form, to the fiber layer of spread unidirectional fibers in form of tows; and bonding a nonwoven veil to at least one side of the fiber layer. Alternatively, the binder is applied as particles or a liquid composition to the nonwoven veil and the veil is then bonded to the fiber layer. In another alternative embodiment, the binder is used in the fabrication of the nonwoven veil. The binder-containing veil is then bonded to the fiber layer of unidirectional fibers.

In one embodiment, the binder is a solid at a temperature of up to 50° C., has a softening point at a temperature in the range of 65° C. to 125° C., and comprises a blend of epoxy resin and thermoplastic polymer, but is void of any catalyst or cross-linking agent which is active above 65° C. The thermoplastic polymer in the binder may be a polyarylsulphone polymer. In one embodiment, the thermoplastic polymer is a polyethersulphone-polyetherether sulphone (PES-PEES) copolymer. The method for making this solid binding material may be found in U.S. Pat. No. 8,927,662, assigned to Cytec Technology Corp., the content of which is incorporated herein by reference.

According to another embodiment, the binder is an aqueous binder dispersion containing (a) one or more multifunctional epoxy resins, (b) at least one thermoplastic polymer, (c) one or more surfactants selected from anionic surfactants and nonionic surfactants, (d) water, and preferably, is essentially free of organic solvents. Optional additives such as organic or inorganic fillers and a defoamer may also be included in the binder composition. The thermoplastic polymer in the binder dispersion may be a polyarylsulphone polymer, for example, PES or a PES-PEES copolymer.

According to another embodiment, two different types of binders are applied to the assembly of unidirectional fibers and nonwoven veil to provide cohesiveness to the resulting laminate. In this embodiment, a first binder, in particulate form or liquid form, is first applied to the fiber layer of unidirectional fibers or the nonwoven veil, the veil is bonded to at least one side of the fiber layer to form a fibrous laminate, followed by applying a second binder, in the form of a liquid composition, to the fibrous laminate, e.g. by dip coating, and drying the binder-treated fibrous laminate in an oven. In an alternative embodiment, the first binder is used in the fabrication of the nonwoven veil. The binder-containing veil is then bonded to the fiber layer of unidirectional fibers to form a fibrous laminate, followed by the application of the second liquid binder and drying.

The liquid binder composition, which may be a polymer emulsion, is applied to coat and infiltrate the fibrous laminate. Water is then evaporated according to a controlled time/temperature profile to achieve the desired physical properties balance. The liquid binder composition is applied so that it is distributed throughout the fibrous laminate.

As an example, the liquid binder composition may be a water-borne dispersion containing: (i) a copolymer of polyhydroxyether and polyurethane, (ii) a cross-linker; and optionally, (iii) a catalyst. The cross-linker may be an aminoplast cross-linker, for example, methoxyalkyl melamine class of aminoplast cross-linkers. The catalyst may include, but are not limited to, proton donating acids such as carboxylic, phosphoric, alkyl acid phosphates, sulfonic, di-sulfonic acids and/or Lewis acids such as aluminum chloride, bromide or halide, ferric halide, boron tri-halides, and many others in both categories as is well known to one skilled in the art.

The total content of binder(s) in the fibrous laminate is about 15% or less by weight, e.g. 0.1 and 15% by weight, based on the total weight of the laminate. Neither the first binder nor the second binder discussed above forms a continuous layer on the surfaces of the fibrous laminate. As such, the fibrous laminate is porous and permeable to molten resin during resin impregnation to form the partially impregnated prepreg.

The application of one or more binders as described above is preferred when the nonwoven veil is composed of carbon fibers or other inorganic fibers.

In some embodiments, the nonwoven veil is made of a thermoplastic material that functions as a binding material. In such embodiments, a single nonwoven thermoplastic veil is bonded to at least one side of the fiber layer of unidirectional fibers by application of heat and pressure. This bonding process is referred to as thermal bonding. The nonwoven thermoplastic veil may be bonded to one side of the fiber layer or on opposite sides of the fiber layer such that the fiber layer is sandwiched between two nonwoven thermoplastic veils. The material of the nonwoven thermoplastic veil may be selected from: polyamides, polyphthalamides, polyimides, polyetherimide (PEI), polyesters, polyphenyleneoxides, thermoplastic polyurethanes, polyacetals, polyolefins, polyarylsulphones (including polyethersulfone (PES), polyetherethersulfone (PEES)), polyphenylene sulfone, polyaryletherketone (PAEK) (including polyetheretherketones (PEEK), polyetherketoneketone (PEKK)), liquid crystal polymers (LCP), phenoxys, acrylics, acrylates, mixtures and copolymers thereof.

As discussed above, the unidirectional fibers may be in the form of continuous fiber tows. Each fiber tow is composed of hundreds of smaller continuous fiber filaments. The fiber tows may have 1000 to 100,000 fiber filaments per tow, and in some embodiments, 3000 to 24000 filaments per tow. The fiber filaments may have cross-sectional diameters within the range of 3-15 μm, preferably 4-7 μm. Suitable fibers are those used as structural reinforcement of high-performance composites, such as composite parts for aerospace and automotive applications. The structural fibers may be made from high-strength materials such as carbon (including graphite), glass (including E-glass or S-glass fibers), quartz, alumina, zirconia, silicon carbide, and other ceramics, and tough polymers such as aramids (including Kevlar), high-modulus polyethylene (PE), polyester, poly-p-phenylene-benzobisoxazole (PBO), and hybrid combinations thereof. For making high-strength composite structures, such as primary parts of an airplane, the unidirectional fibers preferably have a tensile strength of greater than 500 ksi. In a preferred embodiment, the unidirectional fibers are carbon fibers.

Curable Resin

The curable resin layer for forming the partially impregnated prepreg is formed from a thermosettable resin composition containing one or more uncured thermoset resins as major components (making up the largest portion in wt % of composition). Upon curing, the thermoset resins in the resin composition undergo crosslinking, and the composition becomes a hardened material. Suitable thermoset resins include, but are not limited to, epoxy resins, imides (such as polyimide or bismaleimide), vinyl ester resins, cyanate ester resins, isocyanate modified epoxy resins, phenolic resins, furanic resins, benzoxazines, formaldehyde condensate resins (such as with urea, melamine or phenol), polyesters, acrylics, hybrids, blends and combinations thereof. Upon curing, such thermosettable resin composition becomes hardened.

The terms “cure” and “curing” as used in this disclosure refer to the hardening of a material by molecular cross-linking brought about by chemical reaction, ultraviolet radiation or heat. Materials that are “curable” are those capable of being cured, i.e. becoming hardened.

Suitable epoxy resins include polyglycidyl derivatives of aromatic diamine, aromatic mono primary amines, aminophenols, polyhydric phenols, polyhydric alcohols, polycarboxylic acids. Examples of suitable epoxy resins include polyglycidyl ethers of the bisphenols such as bisphenol A, bisphenol F, bisphenol S and bisphenol K; and polyglycidyl ethers of cresol and phenol based novolacs.

Specific examples are tetraglycidyl derivatives of 4,4′-diaminodiphenylmethane (TGDDM), resorcinol diglycidyl ether, triglycidyl-p-aminophenol, triglycidyl-m-aminophenol, bromobisphenol F diglycidyl ether, tetraglycidyl derivatives of diaminodiphenylmethane, trihydroxyphenyl methane triglycidyl ether, polyglycidylether of phenol-formaldehyde novolac, polyglycidylether of o-cresol novolac or tetraglycidyl ether of tetraphenylethane.

Commercially available epoxy resins suitable for use in the host matrix resin include N,N,N′,N′-tetraglycidyl diamino diphenylmethane (e.g. MY 9663, MY 720, and MY 721 from Huntsman); N,N,N′,N′-tetraglycidyl-bis(4-aminophenyl)-1,4-diiso-propylbenzene (e.g. EPON 1071 from Momentive); N,N,N′,N′-tetraclycidyl-bis(4-amino-3,5-dimethylphenyl)-1,4-diisopropylbenzene, (e.g. EPON 1072 from Momentive); triglycidyl ethers of p-aminophenol (e.g. MY 0510 from Hunstman); triglycidyl ethers of m-aminophenol (e.g. MY 0610 from Hunstman); diglycidyl ethers of bisphenol A based materials such as 2,2-bis(4,4′-dihydroxy phenyl) propane (e.g. DER 661 from Dow, or EPON 828 from Momentive, and Novolac resins preferably of viscosity 8-20 Pas at 25° C.; glycidyl ethers of phenol Novolac resins (e.g. DEN 431 or DEN 438 from Dow); di-cyclopentadiene-based phenolic novolac (e.g. Tactix® 556 from Huntsman); and diglycidyl derivative of dihydroxy diphenyl methane (Bisphenol F) (e.g. PY 306 from Huntsman).

Generally, the curable resin composition contains one or more thermoset resins in combination with other additives such as curing agents, curing catalysts, co-monomers, rheology control agents, tackifiers, inorganic or organic fillers, thermoplastic and/or elastomeric polymers as toughening agents, stabilizers, inhibitors, pigments, dyes, flame retardants, reactive diluents, and other additives well known to those skilled in the art for modifying the properties of the matrix resin before or after curing.

The toughening agents may be in the form of polymeric toughening particles. The polymeric toughening particles that are suitable for the purposes herein include thermoplastic or elastomeric particles. For thermoplastic particles, the thermoplastic polymers may be selected from: polyimide, polyamideimide (PAI), polyamide (PA/Nylon), polyphthalamide, polyetherketone. polyetheretherketone, polyetherketoneketone, polyaryletherketones, polyphenylenesulfide, liquid crystal polymers, cross-linked polybutadiene, polyacrylic, polyacrylonitrile, polystyrene, polyetherimide (PEI), polyamide, polyimide, polysulfone, polyethersulfone (PES), poly phenylene oxide (PPO), poly ether ketones, polyaryletherketones (PAEK) such as polyetheretherketone (PEEK) and polyetherketoneketone (PEKK), polyphenyl sulfides (PPS), polyhydroxyethers, styrene-butadiene, polyacrylates, polyacetol, polybutyleneterephthalate, polyamide-imide, polyetherethersulfone (PEES), blends thereof, or copolymers thereof.

The polymeric toughening particles may be of any three-dimensional shape, and in some embodiments, they are substantially spherical. In some embodiments, the toughening particles have an aspect ratio of about 1:1. With reference to toughening particles, the term “aspect ratio” refers to the ratio of the largest cross sectional dimension of the particle to the smallest cross sectional dimension of the particle.

For the purposes disclosed herein, the polymeric toughening particles may have a mean particle size (d50) of less than about 100 μm, for example, within the range of about 10 μm to about 50 μm, or within the range of about 15 μm to about 30 μm. The mean particle sizes as disclosed herein can be measured by a laser diffraction technique, for example, using Malvern Mastersizer 2000 which operates in the 0.002 nanometer-2000 micron range. “d50” represents the median of the particle size distribution, or alternatively is the value on the distribution such that 50% of the particles have a particle size of this value or less.

For spherical particles (with aspect ratio of approximately 1:1), the mean particle size refers to its diameter. For non-spherical particles, the mean particle size refers to the largest cross sectional dimension of the particles.

Generally, if toughening agents are added, they are present in an amount up to 20% by weight based on the total weight of the curable resin composition. If the polymeric toughening particles are added to the composition of the resin layer, the content of the polymeric toughening particles may be about 2% to about 20% by weight based on the total weight of the curable resin layer, for example, about 10% to about 15%.

The toughening particles may be soluble or insoluble in the thermosettable resin composition during curing thereof. Insoluble particles remain as discreet particles in the cured polymer matrix after curing, while soluble particles dissolve into the surrounding resin upon curing the resin. Determining whether certain particles are insoluble or soluble relates to the solubility of the particles in a particular resin system in which they reside.

The addition of curing agent(s) and/or catalyst(s) in the curable resin composition is optional, but the use of such may increase the cure rate and/or reduce the cure temperatures, if desired. The curing agent is suitably selected from known curing agents, for example, aromatic or aliphatic amines, or guanidine derivatives. An aromatic amine curing agent is preferred, preferably an aromatic amine having at least two amino groups per molecule, and particularly preferable are diaminodiphenyl sulphones, for instance where the amino groups are in the meta- or in the para-positions with respect to the sulphone group. Particular examples are 3,3′- and 4,4′-diaminodiphenylsulphone (DDS); methylenedianiline; bis(4-amino-3,5-dimethylphenyl)-1,4-diisopropylbenzene; bis(4-aminophenyl)-1,4-diisopropylbenzene; 4,4′methylenebis-(2,6-diethyl)-aniline (MDEA from Lonza); 4,4′methylenebis-(3-chloro, 2,6-diethyl)-aniline (MCDEA from Lonza); 4,4′methylenebis-(2,6-diisopropyl)-aniline (M-DIPA from Lonza); 3,5-diethyl toluene-2,4/2,6-diamine (D-ETDA 80 from Lonza); 4,4′methylenebis-(2-isopropyl-6-methyl)-aniline (M-MIPA from Lonza); 4-chlorophenyl-N, N-dimethyl-urea (e.g. Monuron); 3,4-dichlorophenyl-N,N-dimethyl-urea (e.g. DIURON™) and dicyanodiamide (e.g. AMICURE™ CG 1200 from Pacific Anchor Chemical).

Suitable curing agents also include anhydrides, particularly polycarboxylic anhydrides, such as nadic anhydride, methylnadic anhydride, phthalic anhydride, tetrahydrophthalic anhydride, hexahydrophthalic anhydride, methyltetrahydrophthalic anhydride, endomethylenetetrahydrophtalic anhydride, and trimellitic anhydride.

Vacuum Bag Only Process

To form a composite structure, the one-side tacky prepreg tapes disclosed herein may be used in an automated placement process, e.g. ATL or AFP, to form a stack of prepreg plies followed by consolidation and curing using a Vacuum Bag Only (VBO) process. An exemplary fabrication method includes the following steps:
a. forming a plurality of one-side tacky prepreg tapes according to any of the methods described above,
b. dispensing, by automation, the prepreg tapes, side-by-side (with controlled gaps if needed), on a tool surface to form a first prepreg ply, wherein the tacky resin surface of each prepreg tape is facing the tool surface;
c. forming one or more subsequent prepreg plies on the first prepreg ply to create a stack of partially impregnated prepreg plies, each subsequent prepreg ply being formed by dispensing, by automation, a plurality of prepreg tapes, side-by-side, on the previously formed prepreg ply such that the resin surface of the subsequent prepreg tape is in contact with the prior formed prepreg ply;
d. enclosing the stack of prepreg plies in a vacuum envelope, which is defined between a flexible, non-porous film and a mold surface;
e. heating the stack of prepreg plies;
f. withdrawing air from the vacuum envelope to create a vacuum pressure sufficient for consolidating the stack of prepreg plies, thereby causing the resin in the prepreg plies to fill in any void spaces within the stack of prepreg plies; and
g. curing the consolidated stack of prepreg plies by applying heat to form a cured composite structure.

The cured composite structured fabricated by the above method is free or substantially free of voids. Voids can be as measured by determining porosity of the composite structure.

The flexible, non-porous film for creating the vacuum envelope may be made of an elastic material such as fluoropolymer.

The mold surface on which the stack of prepreg plies is placed may be a curved surface or have other three dimension configuration representing the shape of the final composite structure.

During the VBO process, the prepreg resin is heated to a temperature that would melt the resin to a low viscosity that allows the resin to flow into the void spaces within the stack of prepreg plies.

### EXAMPLES

### Example 1

A prepreg composed of Cycom 5320-1 resin from Cytec Engineered Materials Inc. and IM-7 unidirectional carbon fibers was manufactured using a dual filming impregnation method at an impregnation level of 92% as measured by water pick-up method. This level of impregnation was needed to assure the prepreg material will slit properly. The prepreg material was subsequently slit into 6.35 mm wide prepreg tapes where a polyester backing layer was temporarily applied. These slit prepreg tapes were then placed by an AFP machine to make test panels. The panels were cured under vacuum in an oven to produce cured laminates.

The porosity of the cured laminate was measured by optical microscopy and was found to be 1.0-2.0%, which is above the acceptable limit of 0.5% for aerospace application. A cross-sectional view of the cured laminate is shown in FIG. 5. The cured laminate shows voids at the interlaminar zones where the tack on the surface of the slit tape where air was trapped during AFP lay-up.

### Example 2

The intent was to move the air removal mechanism to the surface of the prepreg material while maintaining the ability to slit the prepreg material into narrow widths for AFP placement. To accomplish this objective, a binder-coated fiber web of unidirectional carbon fibers was used as the core reinforcement.

An assembly of a carbon fiber web coated with a polyhydroxyether and polyurethane binder (2.5%) and a nonwoven carbon veil was fed into a laminating machine where a single 98 gsm Cycom 5320-1 epoxy resin film was laminated to the veil face with the veil against the heat source on the laminating machine such that only partial impregnation occurred. Impregnation temperature at 170° F., 180° F. and 190° F. were applied in different runs. The resulting material had a tacky surface only on one side and was dry on the other side.

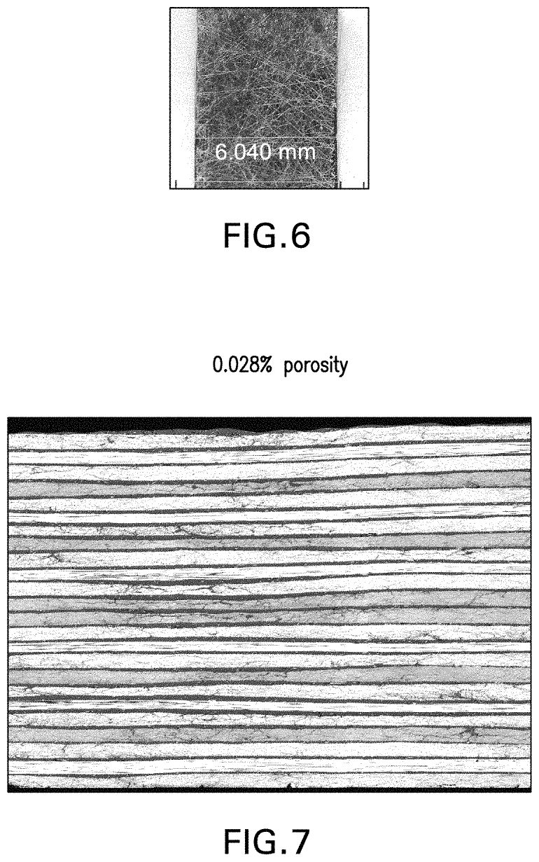

The one-side tacky material was slit into 6.04 mm wide tapes. FIG. 6 shows a top view of a portion of the slit tape formed at 190° F. impregnation temperature.

The slit tapes were used to form a laminate, which was subsequently cured under vacuum of 29 in Hg at 250° F. for 2 hrs, then 350° F. for 2 hrs.

Water pick-up test was carried out by soaking samples of the uncured laminates in water. The weight before and after soaking was measured. The estimated level of impregnation was determined based on the percentage (%) of water uptake. The lowest level of impregnation (in weight %) was found to be 85.15% and the highest was 94.37%. These results show that the partially impregnated prepreg of this example could be slit cleanly without creating fuzzing when the level of impregnation was below 90%. Normally, slitting prepreg having impregnation level below 94% would have been very difficult due to the presence of too much dry fibers.

The cured laminate was sectioned and porosity was measured by optical microscopy. The optical porosity was found to be 0.028%. FIG. 7 shows the cross-sectional view of the cured laminate. The results show that, by shifting the air removal mechanism to the exposed surface of the fiber web by the use of a one-side-tacky material in combination with the binder coated unidirectional fiber web, a low void laminate is possible while preserving the ability to slit the material to narrow width for AFP application.

1. A method for forming a partially impregnated prepreg tape for use in an automated placement process, said method comprising:
bonding a nonwoven veil to a layer of unidirectional fiber tows to form a fibrous laminate;
bringing a layer of curable resin into contact with the fibrous laminate such that the resin is in direct contact with the nonwoven veil;
pressing the layer of curable resin into the fibrous laminate while applying heat and pressure so that the nonwoven veil is embedded in the layer of curable resin and the unidirectional fiber tows are partly surrounded by the curable resin, thereby forming a partially impregnated prepreg having a continuous resin surface only on one side;
slitting the partially impregnated prepreg into narrow-width, continuous prepreg tapes.

2. (canceled)

3. The method of claim 1, wherein the nonwoven veil is comprised of randomly oriented carbon fibers or thermoplastic fibers.

4. The method of claim 1, wherein the nonwoven veil is comprised of randomly oriented carbon fibers, and
wherein the nonwoven veil is bonded to the layer of unidirectional fiber tows by: (i) applying a first binder to at least one of the nonwoven veil and the layer of unidirectional fiber tows, and (ii) bonding the nonwoven veil to the layer of unidirectional fiber tows to form a fibrous laminate.

5. The method of claim 1, wherein the nonwoven veil is comprised of randomly oriented carbon fibers, and
wherein the nonwoven veil is bonded to the layer of unidirectional fiber tows by: (i) applying a first binder to at least one of the nonwoven veil and the layer of unidirectional fiber tows, (ii) bonding the nonwoven veil to the layer of unidirectional fiber tows to form a fibrous laminate, (iii) applying a second binder in liquid form to the fibrous laminate, and (iv) drying the binder-treated fibrous laminate.

6. The method of claim 1, wherein the nonwoven veils are comprised of randomly oriented thermoplastic fibers, and the fibrous laminate is formed by applying heat and pressure to the nonwoven veils so that the veils adhere to the layer of unidirectional fiber tows.

7. (canceled)

8. (canceled)

9. (canceled)

10. The method according to claim 1, wherein the fiber tows are comprised of continuous carbon fibers.

11. A method for forming a composite structure, said method comprising:
forming a plurality of partially impregnated prepreg tapes according to the method of claim 1,
(a) dispensing, by automation, the prepreg tapes, side-by-side, on a tool surface to form a first prepreg ply, wherein the resin surface of each prepreg tape is facing the tool surface;
(b) forming one or more subsequent prepreg plies on the first prepreg ply to form a stack of partially impregnated prepreg plies, each subsequent prepreg ply being formed by dispensing, by automation, a plurality of prepreg tapes, side-by-side, on the previously formed prepreg ply such that the resin surface of the subsequent prepreg tapes are in contact with the prior formed prepreg ply;
(c) enclosing the stack of prepreg plies in a vacuum envelope, which is defined between a flexible, non-porous film and a mold surface;
(d) heating the stack of prepreg plies;
(e) evacuating the vacuum envelope to create a vacuum pressure sufficient for consolidating the stack of prepreg plies, thereby causing the resin in the prepreg plies to fill in any void spaces within the stack of prepreg plies; and
(f) curing the consolidated stack of prepreg plies by applying heat to form a cured composite structure.

12. The method of claim 11, wherein a gap is formed between adjacent prepreg tapes that are dispensed side-by-side at (a).

13. A partially impregnated prepreg tape for use in an automated placement process comprising:
a nonwoven veil bonded to a layer of unidirectional fiber tows;
a layer of curable resin in which the nonwoven veil is embedded,
wherein the unidirectional fiber tows are partly surrounded by the curable resin layer, and
wherein the partially impregnated prepreg tape has a continuous resin surface only on one side and a width in the range of about 0.125 in to about 12 in (or about 0.3 cm to about 30.5 cm).

14. (canceled)

15. The partially impregnated prepreg tape according to claim 13, having a length that is at least 10 times its width.

16. The partially impregnated prepreg tape according to claim 13, further comprising polymeric particles embedded in the layer of curable resin.

17. The partially impregnated prepreg tape according to claim 13, wherein the layer of curable resin comprises one or more epoxy resin(s) and a curing agent.

18. The partially impregnated prepreg tape according to claim 13, wherein the unidirectional fiber tows are unidirectional carbon fiber tows.

19. The partially impregnated prepreg tape according to claim 13, 15 to 17, wherein the nonwoven veil is composed of randomly arranged thermoplastic fibers or carbon fibers or a combination thereof.

20. The partially impregnated prepreg tape according to claim 13, wherein the first and second nonwoven veils are composed of randomly arranged fibers selected from thermoplastic fibers, carbon fibers, and combination thereof.
